(19) United States
(12) Patent Application Publication
(10) Pub. No.: US 2006/0292922 A1
(43) Pub. Date: Dec. 28, 2006

(54) Process for connecting terminal elements to an electrical conductor consisting of aluminum, and electrical conductor produced by the process

(75) Inventor: Karl Franz Froschl, Herrnbaumgarten (AT)

Correspondence Address: LERNER GREENBERG STEMER LLP, P O BOX 2480, HOLLYWOOD, FL, 33022-2480, US

(73) Assignee: Gebauer & Griller Kabelwerke Gesellschaft m.b.H.

(21) Appl. No.: 11/511,019

(22) Filed: Aug. 28, 2006

Related U.S. Application Data
(63) Continuation of application No. PCT/AT04/00358, filed on Oct. 21, 2004.

(30) Foreign Application Priority Data
Mar. 23, 2004 (AT) 507/2004

(51) Int. Cl. H01R 4/26

(52) U.S. Cl. 439/442

(57) ABSTRACT

A method for joining a connecting element, which is made of copper or a copper alloy, for a cable, particularly a cable lug, to an electric cable provided with a conductor that is made of aluminium. The connecting element, which is provided with a nickel coating on the surfaces thereof facing away from the aluminium conductor, is welded to the aluminium conductor by way of zinc.

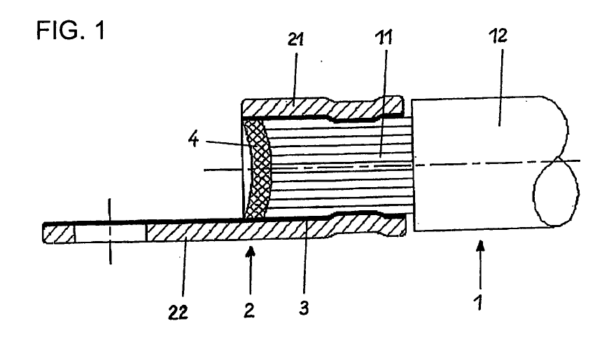

### CROSS-REFERENCE TO RELATED APPLICATION

This is a continuing application of copending international application PCT/AT2004/000358, filed Oct. 21, 2004, the priority of which is claimed under 35 U.S.C. § 120; the application also claims the the priority, under 35 U.S.C. § 119, of Austrian patent application No. A 507/2004, filed Mar. 23, 2004; the prior applications are incorporated herein by reference in their entirety.

### BACKGROUND OF THE INVENTION

### Field of the Invention

The present invention relates to a process for connecting a connection element for a cable, in particular a cable lug. The connection element is formed of copper or a copper alloy, and it is connected to an electric cable which has a conductor consisting of aluminum. The invention also relates to an electrical conductor configured with a connection element and produced by this process.

It has been known in the pertinent art to produce electrical conductors, in particular those used in motor vehicles, from aluminum. The advantages of electrical conductors produced from aluminum are that aluminum is significantly less expensive than other metals, in particular copper, from which electrical conductors are also made, that it has a low weight, that it is easy to process and that it is very resistant to corrosion. However, the reason that, despite its particular advantages, aluminum is not in general use for the production of electrical conductors is that it has a significantly lower strength than other metals, and consequently the terminal elements, in particular cable lugs, have to be made from different metals, in particular from copper alloys, such as brass. However, this imposes the requirement that in particular the terminal elements made from copper alloys have to be permanently connected to the aluminum conductors.

To connect aluminum conductors to terminal elements, in particular to cable lugs, it is known for them to be adhesively bonded by means of an electrically conducting plastics material, for them to be soldered or welded together or for them to be connected to one another in a positively locking manner by deformation or compression. However, in this context it is also necessary to satisfy the requirement that the aluminum conductor is not in direct contact with the terminal element consisting of copper or a copper alloy or the like, since otherwise, if a liquid acting as an electrolyte takes effect at this connection, an electrochemical process occurs, destroying the aluminum conductor, thereby breaking the electrical and mechanical connection.

### SUMMARY OF THE INVENTION

The present invention is therefore based on the object of providing a process which, while avoiding the difficulties which have been outlined above, provides a way of permanently connecting a conductor consisting of aluminum to a terminal element consisting of copper or a copper alloy.

With the foregoing and other objects in view there is provided, in accordance with the invention, a process for connecting a terminal element to a cable conductor formed of aluminum, the process which comprises:

providing a terminal element consisting essentially of copper or a copper alloy and carrying a nickel coating on surfaces thereof configured to face the conductor; and

welding the terminal element with the nickel coating to the aluminum conductor by with zinc.

In other words, the objects of the invention are achieved in that the terminal element, which is provided with a nickel coating on its surfaces which face the aluminum conductor, is welded to the aluminum conductor by means of zinc.

Preferably, the zinc which is present between the terminal element and the aluminum conductor is fused to the aluminum conductor, in particular by means of a plasma welding process. According to another preferred embodiment, the terminal element has a sleeve which is fitted onto the aluminum conductor, and the zinc is applied to that end face of the aluminum conductor which is located within the sleeve and is fused to the aluminum conductor and to the terminal element. Furthermore, the sleeve and the aluminum conductor can also be connected to one another by mechanical deformation of the sleeve.

An aluminum electrical conductor according to the invention which is designed with at least one terminal element consisting of copper or a copper alloy is wherein the terminal element is designed with a nickel coating on those surfaces which face the aluminum conductor, and in that, furthermore, a layer of zinc is located between the nickel coating and the aluminum conductor, the layer of zinc preferably being provided on that end face of the aluminum conductor which is located inside the sleeve.

In accordance with an added feature of the invention, the terminal element, or connector, is a cable lug.

In accordance with an additional feature of the invention, the zinc that is present between the terminal element and the aluminum conductor is fused to the aluminum conductor, preferably by a plasma welding process.

In accordance with another feature of the invention, the sleeve and the aluminum conductor are also connected to one another by mechanical deformation of the sleeve, or by crimping the sleeve.

With the above and other objects in view there is also provided, in accordance with the invention, an electrical conductor made from aluminum, which is designed with at least one terminal element consisting of copper or a copper alloy and which is produced by the process as outlined above. The terminal element is formed with a nickel coating on those surfaces which face the aluminum conductor, and in that, furthermore, a layer of zinc is located between the nickel coating and the aluminum conductor.

In accordance with a further feature of the invention, the terminal element is formed with a sleeve that surrounds the aluminum conductor, and a layer of zinc is located on that end face of the aluminum conductor which is located inside the sleeve.

With the above and other objects in view there is also provided a connector assembly, which comprises: an electrical conductor of aluminum; at least one terminal element essentially consisting of copper or a copper alloy; said terminal element having a nickel coating on surfaces facing toward said aluminum conductor; and a layer of zinc disposed between said nickel coating and said aluminum conductor.

Other features which are considered as characteristic for the invention are set forth in the appended claims.

Although the invention is illustrated and described herein as embodied in a process for connecting a terminal element to an electrical conductor consisting of aluminum, and an electrical conductor produced by this process, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The sole figure is an axial section taken through an electrical cable formed with a terminal element according to the invention.

### DESCRIPTION OF THE PREFERRED EMBODIMENTS

Referring now to the figure of the drawing in detail, the is shown an electric cable 1 which comprises an electrical conductor 11, which is preferably formed by a multiplicity of aluminum wires and is enclosed by an insulation 12.

A terminal element 2, which may also be referred to as a connector or a connection element 2 and which is formed by a sleeve 21 and a terminal lug 22, is applied to the electrical conductor at the end of the cable 1 from which the insulation jacket 12 has been stripped. The terminal element 2 is provided with a coating 3 consisting of nickel at least on those surfaces which face towards the electrical conductor 11.

Inside the sleeve 21, a layer 4 of zinc has been applied to the end face of the electrical conductor 11 and has been connected to the conductor 11 by a fusion operation brought about by way of a plasma welding process. The electrical connection of the copper connector, or terminal element 2, to the aluminum conductor 11 is therefore effected by means of the nickel coating 3 and the zinc layer 4. Moreover, the sleeve 21 can be connected to the conductor 11 by mechanical deformation of the sleeve 21, i.e., by crimping.

Copper has a melting point of 1085° C. (1981° F.), nickel has a melting point of 1453° C. (2646° F.), zinc has a melting point of 419° C. (786° F.), and aluminum has a melting point of 660° C. (1218° F.).

When forming the connection between the terminal element 2 and the cable 1 in this way, it is crucial for the aluminum conductor 11 of the cable 1 not to be directly connected to the terminal element 2 consisting of copper or a copper alloy, but rather for two layers 3 and 4 consisting of metals which lie between aluminum and copper in the electrochemical series to be located between these two components, thereby very greatly reducing the risk of damage to the aluminum conductor 11.

The crucial factor in this effect is that aluminum has a standard potential E° of −1.676 volts and copper has a standard potential of at least 0.337 volts, in each case measured against a standard hydrogen electrode. The potential difference between these two metals causes decomposition of the aluminum if an electrolyte is present. However, if there is at least one metal whose standard potential is between that of aluminum and copper located between these two metals, the potential differences which occur between the respective metals are reduced, thereby greatly lowering the risk of electrochemical decomposition.

In addition to this combination of metals, which substantially avoids electrolytic decomposition of the connection between the aluminum conductor 11 and the terminal element 2, the process for producing this connection is also crucial, consisting in applying a large quantity of energy to the layer 4 of zinc located between the nickel coating 3 of the terminal element 2 and the aluminum conductor 11, in particular by means of a plasma welding process, with the result that the zinc and the aluminum wires with which it is in contact are fused and form an alloy with one another. As a result, the terminal element 2 provided with the nickel coating 3 is optimally connected to the aluminum conductor 11. Since the nickel coating 3 has a very high melting point compared to the zinc layer 4, the contact surfaces of the nickel coating 3 are not damaged or the surface quality of the nickel coating 3 on the terminal element 2 is retained.

The combination of metals which has been explained and the process which has been explained involving welding to connect the terminal element 2 made from copper or a copper alloy to the aluminum conductor 11 ensures that the corrosion resistance of this connection is so high that there is no need for measures for sealing the connection, for example by the application of grease.

I claim:

1. A process for connecting a terminal element to a cable conductor formed of aluminum, the process which comprises:
providing a terminal element consisting essentially of copper or a copper alloy and carrying a nickel coating on surfaces thereof configured to face the conductor; and
welding the terminal element with the nickel coating to the aluminum conductor by with zinc.

2. The process according to claim 1, which comprises forming the terminal element as a cable lug.

3. The process according to claim 1, which comprises fusing the zinc that is present between the terminal element and the aluminum conductor to the aluminum conductor.

4. The process according to claim 3, which comprises fusing the zinc to the aluminum conductor by way of a plasma welding process.

5. The process according to claim 1, which comprises fitting a sleeve of the terminal element onto the aluminum conductor, and fusing the zinc applied to an end face of the aluminum conductor disposed within the sleeve to the aluminum conductor and to the terminal element.

6. The process according to claim 5, which further comprises connecting the sleeve and the aluminum conductor to one another by mechanical deformation of the sleeve.

7. The process according to claim 5, which further comprises crimping the sleeve onto the aluminum conductor.

8. An assembly, comprising:
an electrical conductor of aluminum;
at least one terminal element essentially consisting of copper or a copper alloy and produced by the process according to claim 1;
said terminal element having a nickel coating on the surfaces facing said aluminum conductor; and
a layer of zinc disposed between said nickel coating and said aluminum conductor.

9. The electrical conductor according to claim 8, wherein said terminal element is formed with a sleeve surrounding said aluminum conductor, and a layer of zinc is disposed on an end face of said aluminum conductor disposed inside said sleeve.

10. An assembly, comprising:
an electrical conductor of aluminum;
at least one terminal element essentially consisting of copper or a copper alloy;
said terminal element having a nickel coating on surfaces facing toward said aluminum conductor; and
a layer of zinc disposed between said nickel coating and said aluminum conductor.
